(19) United States
(12) Patent Application Publication
(10) Pub. No.: US 2008/0276464 A1
(43) Pub. Date: Nov. 13, 2008

(54) Multi-cut lopper

(75) Inventor: Joshua D. Hatch, Middleton, WI (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/800,698

(22) Filed: May 7, 2007

(51) Int. Cl. B26B 13/00

(52) U.S. Cl. 30/244

(57) ABSTRACT

A hand-operated cutting tool includes a first handle coupled to a first jaw, with the first jaw having a blade, and a second handle coupled to a second jaw, with the second jaw having a first hook configured to receive a first object, and a second hook configured to receive a second object, where the first hook is larger than the second hook, and the first object is larger than the second object. A pivot connection couples the first jaw to the second jaw so that movement of the handles from a closed position to an intermediate position exposes the second hook for receiving and cutting the second object only, and movement of the handles from the intermediate position to an open position exposes the first hook for receiving and cutting the first object.

### FIELD

The present invention relates to a hand-operated cutting tool. The present invention relates more particularly to a hand-operated cutting tool, typically referred to as a lopper, having a pair of handles that actuate a pair of cutting jaws. The present invention relates more particularly to a lopper with a jaw having multiple cutting features for capturing and severing an object in the jaws.

### BACKGROUND

It is generally known to provide a hand-operated cutting tool for use in pruning or trimming branches and the like, such as a lopper having a pair of pivoting members such as handles that actuate cutting jaws that cooperate to capture and sever a branch between the jaws. Such known loppers typically include a pair of handles pivotally movable between an open and closed position for actuating the cutting jaws between a full open and closed position. The known loppers may also devices intended to increase the available leverage provided by the handles, including levers and/or gears that transmit and increase a force from the handles to the jaws. However, the jaws of such known loppers typically have a single cutting feature (e.g. notch, recess, hook, cutout, etc.) intended to capture a branch (or other suitable object) for retention within, and severing between, the cutting jaws. The cutting feature is typically arranged so that it is accessible for capturing the branch when the handles of the lopper are at (or near) a full-open position, so that relatively large branches may be captured between the jaws in a position where maximum leverage and cutting force can be applied to the branch from the handles.

Such known loppers with a singular cutting feature are generally effective for cutting branches having a relatively large diameter, but suffer from certain disadvantages when cutting smaller sized branches. For example, the known lopper is also often used to cut relatively small diameter branches or twigs, where a relatively small leverage and cutting force is sufficient to sever the small branch or twig. However, in order to capture the small branch or twig within the cutting feature, the handles of the lopper must be opened at (or near) the full-open position that corresponds to the maximum leverage position used with the larger branches. This drawback typically requires a user to expend unnecessary effort opening and closing the handles (and jaws) of the lopper through a much greater range of travel than is necessary when cutting or pruning small branches or twigs.

Accordingly, it would be desirable to provide a hand-operated cutting tool, such as a lopper, having a pair of jaws with multiple cutting features. It would also be desirable to provide a lopper having a jaw with multiple cutting features that are arranged on the jaw for capturing and cutting large branches at a location that corresponds to an increased leverage handle position (i.e. requiring a larger range of handle motion). It would also be desirable to provide a lopper having a jaw with multiple cutting features that are arranged on the jaw for capturing and cutting small branches or twigs at a location that corresponds to a decreased leverage handle position (i.e. requiring a smaller range of handle motion). It would be further desirable to provide a lopper having a jaw with multiple cutting features that are arranged on the jaw for capturing and cutting variable sized branches at jaw locations that corresponds to an appropriate leverage handle position and handle range of motion. It would also be desirable to provide a lopper having a selectively engageable stop for retaining the handles in a position corresponding to one or more of the cutting features. It would also be desirable to provide a lopper having a biasing device for assisting the movement of the handles in the open direction.

Accordingly, it would be desirable to provide a hand-operated cutting tool, such as a lopper, having any one or more of these or other desirable features.

### SUMMARY

According to one embodiment, a hand-operated cutting tool includes a first handle coupled to a first jaw, with the first jaw having a blade, and a second handle coupled to a second jaw, with the second jaw pivotally coupled to the first jaw at a pivot point. The second jaw includes a first hook near the pivot point for receiving a first object, and a second hook distant from the pivot point for receiving a second object. Where the first hook is larger than the second hook, and the first object is larger than the second object.

According to another embodiment, a hand-operated cutting tool, includes a first handle operably coupled to a first jaw and a second handle operably coupled to a second jaw. The first jaw and the second jaw are pivotally coupled to one another so that movement of the handles relative to one another between a closed position and an intermediate position and an open position, results in a corresponding movement of the jaws between a closed position and an intermediate position and an open position. The first jaw includes a blade, and the second jaw includes a first hook for receiving a first object, and a second hook for receiving a second object. The second hook is configured to receive the second object when the handles are moved from the closed position to the intermediate position, so that the jaws are capable of receiving and severing the second object without moving the handles to the open position.

According to a further embodiment, a hand-operated cutting tool includes a first handle coupled to a first jaw, with the first jaw having a blade. A second handle is coupled to a second jaw, with the second jaw having a first hook for receiving a first object, and a second hook for receiving a second object, where the first hook is larger than the second hook, and the first object is larger than the second object. A pivot connection couples the first jaw to the second jaw so that movement of the handles from a closed position to an intermediate position exposes the second hook for receiving and cutting the second object only, and movement of the handles from the intermediate position to an open position exposes the first hook for receiving and cutting the first object.

### BRIEF DESCRIPTION OF THE DRAWINGS

FIG. 1 is a schematic image of an elevation view of a hand-operated cutting tool, such as a lopper, in a full closed position and having multiple cutting features according to an exemplary embodiment.

FIG. 2is a schematic image of the lopper shown in FIG. 1 in a full open position according to an exemplary embodiment.

FIG. 3is a schematic image of the lopper shown in FIG. 1 in a partially open (e.g. intermediate) position corresponding to a cutting feature for small branches, according to an exemplary embodiment.

FIG. 4 is a partial perspective view of the lopper shown in FIG. 3 in a partially open (e.g. intermediate) position corresponding to a cutting feature for small branches, according to an exemplary embodiment.

FIG. 5 is a schematic image of a partial perspective view of the lopper shown in FIG. 2 in a full open position corresponding to a cutting feature for large branches, according to an exemplary embodiment.

FIG. 6 is a schematic image of partial perspective view of a lopper in a full open position and having multiple cutting features according to another exemplary embodiment.

FIG. 7 is a schematic image of partial perspective view of a lopper in a full open position and having multiple cutting features according to another exemplary embodiment.

FIG. 8 is a schematic image of partial perspective view of a lopper in a full open position and having multiple cutting features according to another exemplary embodiment.

### DETAILED DESCRIPTION

Referring to the FIGURES, a hand-operated cutting tool, shown for example as a “lopper” having a pair of handles operable to actuate a pair of jaws, is illustrated having multiple cutting features (such as notches, recesses, cutouts, etc.—shown and described herein by way of example as “hooks”) provided on one jaw for capturing an object between the jaws so that the object is sufficiently retained by the hook for cutting/severing the object with a blade provided on the other jaw. A first (e.g. main, primary, large, etc.) hook is arranged on the jaw for capturing and cutting “large” objects at a location near a base of the jaw that corresponds to an increased leverage handle position (i.e. associated with a larger/wider range of handle motion) that is advantageous for cutting large objects such as “thick” branches, etc. A second (e.g. supplemental, secondary, auxiliary, small, etc.) hook is also arranged on the jaw for capturing and cutting small objects (e.g. slender branches or twigs at a location that corresponds to a decreased leverage handle position (i.e. associated with a smaller/narrow range of handle motion). Through the use of multiple (e.g. two or more) hooks on a single jaw of the lopper, various sized objects may be cut using a handle range of motion that corresponds to a desired leverage that is appropriate for cutting an object that corresponds to the size of the hook. For example, small objects requiring less leverage may be cut by opening the handles through a relatively small or narrow range of travel to expose the second hook, so that the small object may be received in the second hook and cut by closing the handles. Use of the second hook is intended to avoid having to open the handles through a wide or full range of travel to capture small objects (which do not require such leverage) in a main/large hook for cutting, as is often required in traditional loppers.

The lopper may also be selectively “set” for use with either the large hook (for large objects) or the small hook (for small objects) by using a releasable stop (e.g. in the form of a slide-lock, push-button or the like). When the stop is activated or “set” the handles may be opened sufficiently to expose the second hook (e.g. an intermediate position of handle travel), but are generally prevented from opening further, such as when a user desires to cut only small objects with the lopper. In addition, a spring may be provided (e.g. between the handles, between the jaws, about the pivot point, etc.—with or without the stop) to bias the handles in an open direction from the closed position. For example, when the stop and spring are used together, the spring biases the handles toward the intermediate position (e.g. after each cutting operation), where the handles are maintained in a “rest” state against the stop, so that a user need only actuate the lopper handles in the closed direction for successive cutting operations on small objects. The stop may also be deactivated or released to permit opening movement of the handles through a full range of travel sufficient to expose the first hook, such as when a user also desires to cut large objects.

It should be noted that additional hooks may also be provided on the jaw at strategic locations for providing a variable size/effort cutting capability. For example, a third hook may be provided having a medium/intermediate size for use with medium sized objects, and located on the jaw at a location corresponding to a medium degree of leverage provided by the handles. Additionally, multiple “second” hooks may be provided at different locations on the jaw for convenience in accessing the object to be cut by the lopper. It should also be noted that the provision of multiple hooks on a jaw of a lopper may be provided on a lopper having any suitable device for actuating the jaws by operation of the handles. For example, the lopper illustrated in the FIGURES is shown to have an actuating lever intended to increase the leverage provided to the jaws from the handles. However, other types of actuating devices may be used, such as intermeshing gears, a single pivot connection, a double pivot connection, etc. Accordingly, the embodiments illustrated in the FIGURES are shown by way of example, and any of a wide variety of other hook numbers/sizes/configurations, and cutting device types (e.g. snips, pruners, shears, etc.), and actuating devices, and combinations thereof, will be readily apparent to a person of ordinary skill in the art after reviewing this disclosure. All such variations are intended to be within the scope of the invention.

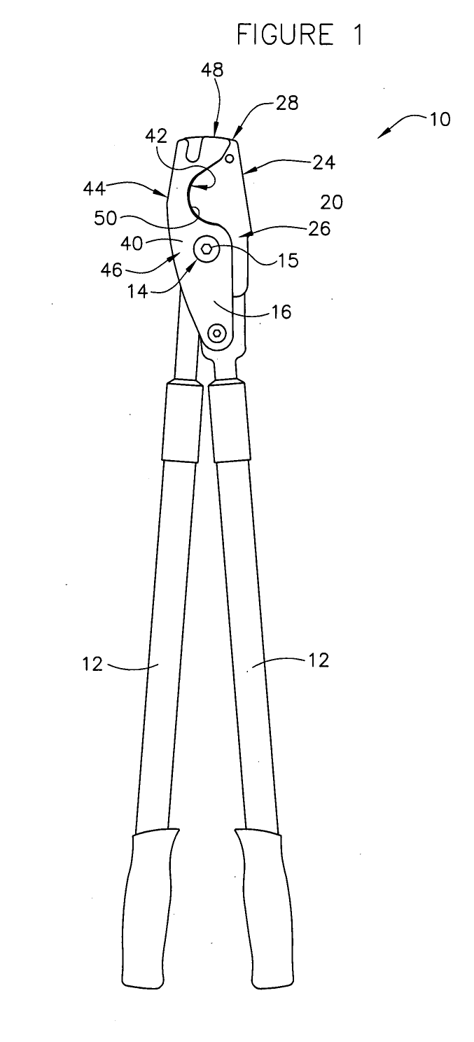

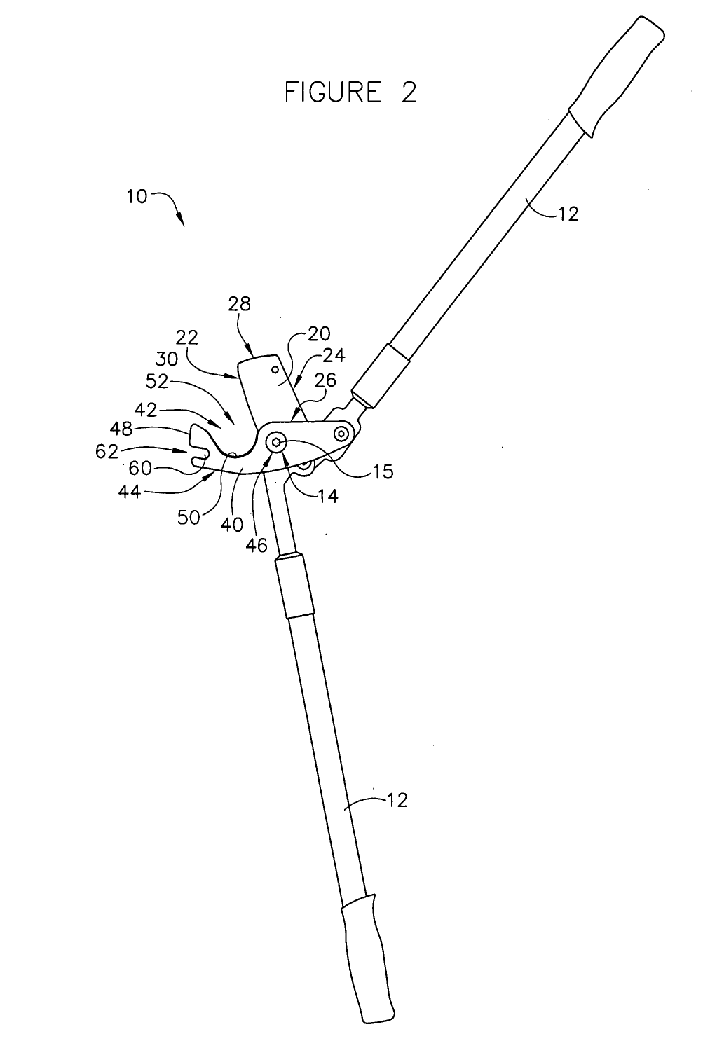

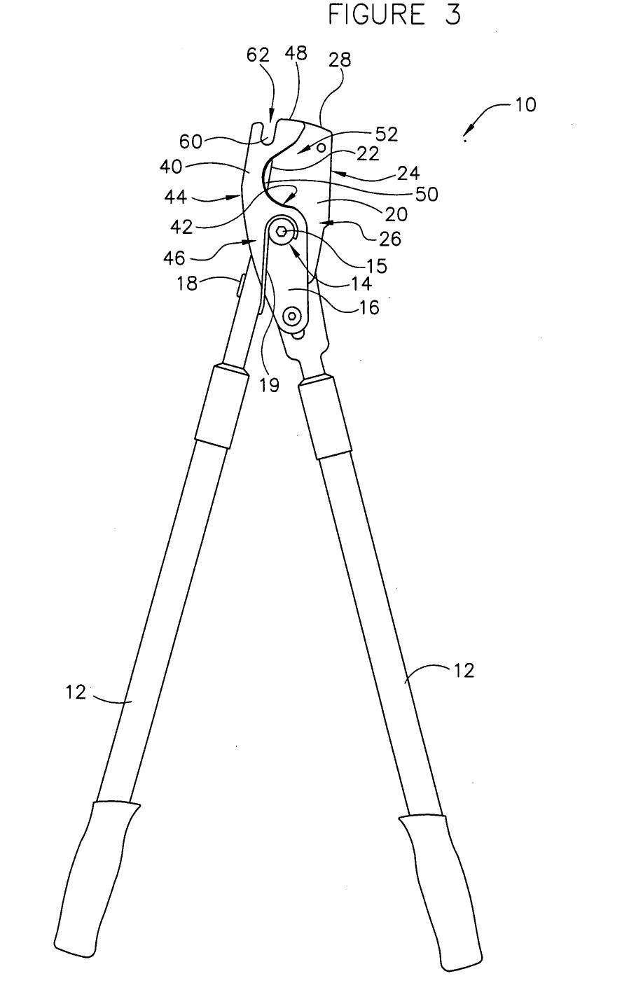

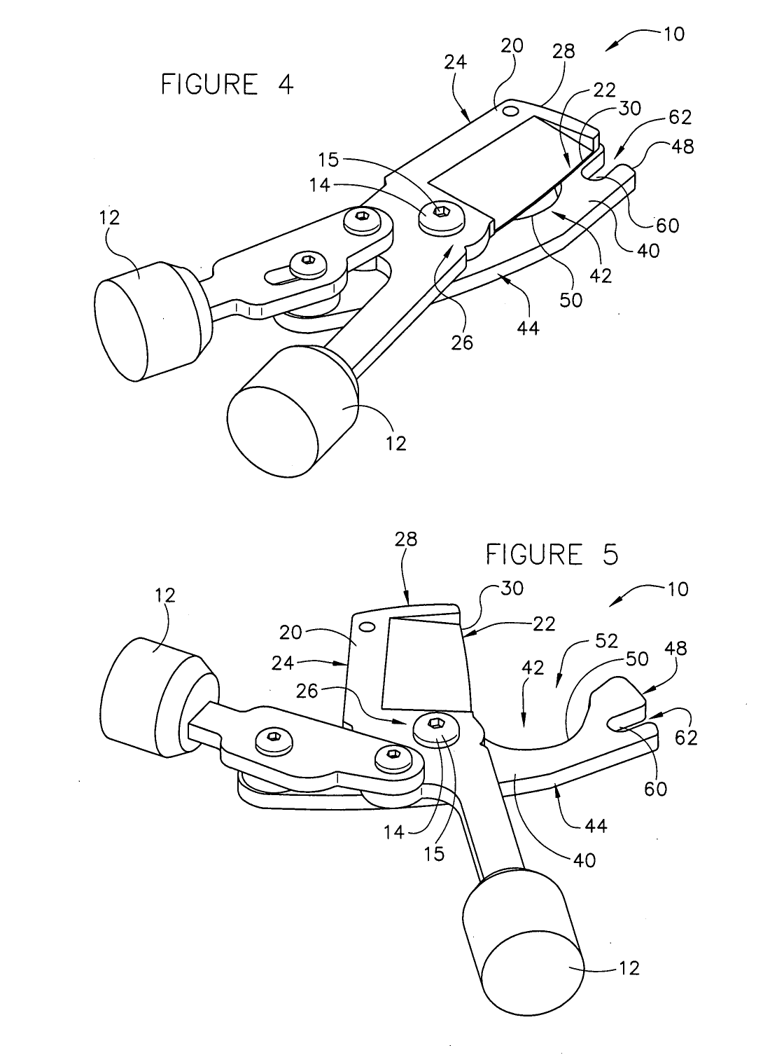

Referring more particularly to FIGS. 1-5, a hand-operated cutting device, shown for example as a lopper 10, having multiple hooks is shown in a closed position (see FIG. 1) and an open position (see FIG. 2 and 5) and an intermediate position (see FIG. 3 and 4) according to an exemplary embodiment. Lopper 10 is shown to include a pair of handles 12 and a pair of jaws. A first jaw 20 is coupled to a second jaw 40 by a pivot connection 14 at a pivot point 15. The lopper 10 is also shown to include an actuating device in the form of a lever 16 for increasing the leverage provided to the jaws from the handles. The first jaw includes an internal side 22, an external side 24, a base 26 generally surrounding the pivot point 15, and an end 28 extending between the internal side 22 and the external side 24. Internal side 22 of the first jaw 20 includes a sharpened edge forming a cutting edge or blade 30 for cutting or severing an object between the jaws. The second jaw 40 includes an internal side 42 (facing the internal side 22 of the first jaw 20), an external side 44, a base 46 generally surrounding the pivot point 15, and an end 48 extending between the internal side 42 and the external side 44. Internal side 42 of the second jaw 40 is shown to include a first hook 50 near or proximate the base 46 and the pivot point 15, and having an opening 52 facing toward the blade 30.

First hook 50 is shown as a relatively large notch, recess or cutout sized to receive relatively large objects (e.g. thick branches, etc.) located adjacent to the pivot point 15 for maximizing the cutting force applied by a user when moving the handles 12 from the open position (see FIG. 1) to the closed position (see FIG. 2). In operation, a user may move the handles to a wide or full open position to expose the first hook 50 for receiving a large object (such as may require a larger amount of leverage for cutting). The object may then be cut or severed by moving the handles 12 from the wide or full open position to the closed position, so that the blade 30 slides past the first hook 50 in a shearing relationship.

Referring further to FIGS. 1-5, a second hook 60 is shown on the second jaw 40 according to one embodiment. Second hook 60 is shown as a relatively small notch, recess or cutout sized to receive smaller objects (e.g. slender branches, twigs, etc.) to be cut by the lopper, and positioned along the end 48 of the second jaw 40 (i.e. distant from the base 46 and pivot point 15). According to the illustrated embodiment, an opening 62 of the second hook 40 extends generally parallel with end 48 and transverse to blade 30. Positioning of the second hook 60 on the end 48 of the jaw 40 has the additional advantage of providing a tool with a narrow approach profile that can be inserted into tight or congested applications for cutting (e.g. clipping, nipping, snipping, etc.) hard-to-reach objects.

In operation, the handles 12 may be moved by a user from the closed position (see FIG. 1) to an intermediate position (corresponding to sufficient leverage for cutting a smaller object—see FIGS. 3 and 4) to expose the second hook 60, so that a smaller object may be received through the opening 62 and captured within the second hook 60. The object may then be cut or severed by moving the handles 12 from the intermediate position to the closed position, so that the blade 30 slides past the second hook 60 in a shearing relationship, without having to open the handles 12 to a wide or full open position (such as shown for example in FIGS. 2 and 5).

Accordingly, the lopper 10 as shown in FIGS. 1-5 is capable of cutting larger objects captured in a main hook with the handles extended for maximum leverage, and is also capable of cutting smaller object captured in an auxiliary hook with reduced extension of the handles (i.e. opened to an intermediate position as shown in FIG. 3) where reduced leverage (and effort by a user) is sufficient to accomplish the cutting operation.

Referring further to FIG. 3, the lopper 10 may also include a selectively actuatable “stop” 18 (e.g. lock, limit, etc.) that may be releasably engaged to prevent opening the handles beyond the intermediate position (or any other desired position), according to another embodiment. Engaging the stop is intended to limit the opening range of motion of the handles when the lopper is used in a mode where only small objects will be cut, to further enhance the ease of use. The stop 18 is shown for example as a slide lock (but may be any other suitable stop device, such as a push-button, etc.) that may be selectively engaged to abut the second side 44 of the second jaw 40 to prevent the handles 12 (and the jaws) from opening beyond the intermediate position. The stop 18 may also be selectively released (disengaged, etc.) to permit a wider opening range of handle motion when a user desires to cut larger objects in the first hook.

Referring further to FIG. 3, the lopper 10 may also include a biasing device (shown for example as a spring 19) configured to bias the handles 12 from the closed position toward the intermediate position (and/or the open position) so that the handles are “sprung-open” according to another embodiment. The spring 19 may be provided with or without the stop 18, and is shown by way of example to be a torsion spring, but may be any suitable type of spring for biasing the handles in an open direction. The spring 19, in combination with the stop 18, cooperate to enhance the ease of use of the lopper on small objects (e.g. in a similar manner as a hand-pruner having a sprung-open arrangement). With the stop 18 engaged, the “rest” state of the lopper would be with the handles biased by spring 19 into the intermediate position and the second hook exposed and ready for receiving small objects. A user may then cut the small objects by simply moving the handles from the intermediate position to the closed position, whereupon the spring 19 returns (or assists in the return of) the handles to the intermediate position for reinitiating the cutting operation on other small objects. With the stop 18 disengaged, the spring 19 is intended to assist a user by biasing the handles toward the wide or full open position to access the first hook when cutting larger objects.

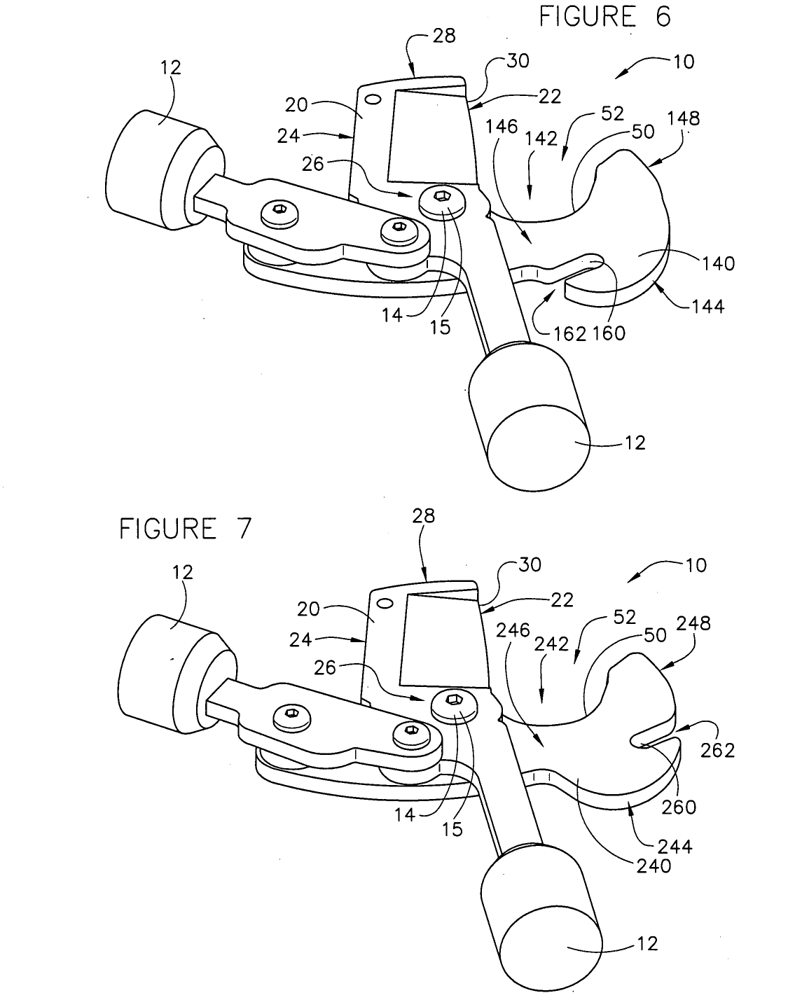

Referring to FIG. 6, a lopper 10 is shown having a second hook 160 at an alternative location according to an exemplary embodiment. Second hook 160 is shown by way of example to be provided along an external side 144 of the second jaw 140, and having an opening 162 facing toward the base 146 of the second jaw (or toward the handles or pivot point). The lopper with second hook 140 operates in a similar manner to the lopper as previously described, however, the alternative location for the second hook provides the advantage of being able to capture smaller objects through the opening 146 and permit a user to “pull” the object before cutting (as is often desirable with vines and the like).

Referring to FIG. 7, a lopper 10 is shown having a second hook 260 at another alternative location according to an exemplary embodiment. Second hook 260 is shown by way of example to be provided along an external side 244 of the second jaw 240, and having an opening 262 facing away from the base 246 of the second jaw (or away from the handles or pivot point). The lopper with second hook 240 operates in a similar manner to the lopper as previously described, however, the alternative location provides the advantage of being able to capture smaller objects through the opening 248 and “push” the object away from a user (e.g. stretching the object, etc.) before cutting.

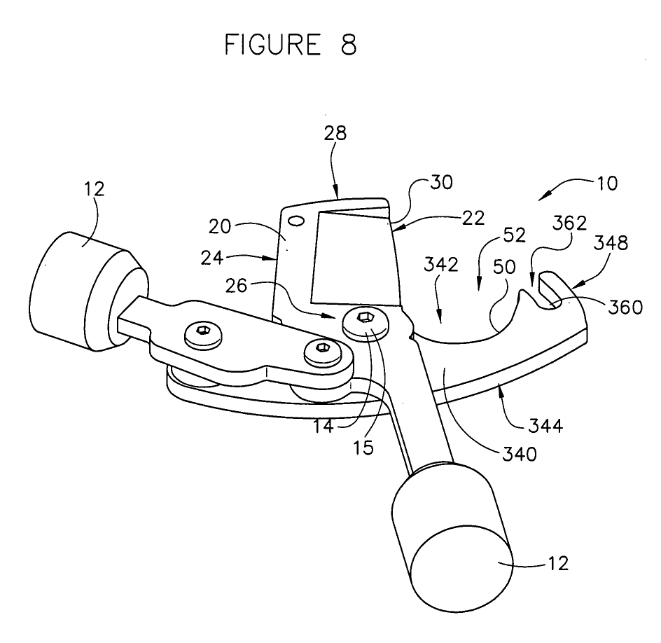

Referring to FIG. 8, a lopper 10 is shown having a second hook 360 at yet another alternative location according to an exemplary embodiment. Second hook 360 is shown by way of example to be provided along internal side 342 of the second jaw 340, and having an opening 362 facing toward the blade 30 of the first jaw 20 and located between (and adjacent to) the first hook 50 and the end of the second jaw 348. The lopper with second hook 360 operates in a similar manner to the lopper as previously described, however, the alternative location provides the advantage of having both hooks inwardly directed to minimize the likelihood of the hooks “catching” on other objects when working in congested or delicate areas.

According to any exemplary embodiment, a hand-operated multi-function cutting tool, shown for example as a lever-actuated lopper, includes a main hook that is sized and positioned on a jaw for cutting larger objects requiring greater leverage, and at least one supplemental hook sized and positioned on the jaw for cutting smaller objects requiring lesser leverage, so that handles of the lopper may be operated though a range of travel that corresponds to the size of the object and the appropriate leverage for cutting the object.

It is also important to note that the construction and arrangement of the elements of the hand-operated cutting tool, shown as a lopper, with multiple hooks as shown schematically in the embodiments is illustrative only. Although only a few embodiments have been described in detail in this disclosure, those skilled in the art who review this disclosure will readily appreciate that many modifications are possible without materially departing from the novel teachings and advantages of the subject matter recited.

Accordingly, all such modifications are intended to be included within the scope of the present invention. Other substitutions, modifications, changes and omissions may be made in the design, operating conditions and arrangement of the preferred and other exemplary embodiments without departing from the spirit of the present invention.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present invention as expressed in the appended claims.

What is claimed is:

1. A hand-operated cutting tool, comprising:
a first handle coupled to a first jaw, the first jaw comprising a blade;
a second handle coupled to a second jaw, the second jaw pivotally coupled to the first jaw at a pivot point;
the second jaw comprising a first hook proximate the pivot point and configured to receive a first object, and a second hook distal to the pivot point and configured to receive a second object;
wherein the first hook is larger than the second hook, and the first object is larger than the second object.

2. The tool of claim 1 wherein the handles are movable relative to each other in a range between a closed position and an intermediate position and an open position, for a corresponding movement of the jaws between a closed position and an intermediate position and an open position.

3. The tool of claim 2 wherein the second hook is configured to receive the second object when the handles are moved to the intermediate position, so that the jaws are capable of receiving and severing the second object without moving the handles to the open position.

4. The tool of claim 3 wherein the first hook is configured to receive the first object when the handles are moved to the open position.

5. The tool of claim 2 further comprising a selectively engageable stop configured to prevent opening movement of the handles beyond the intermediate position.

6. The tool of claim 5 further comprising a spring configured to bias the handles in an opening direction toward the intermediate position.

7. The tool of claim 1 wherein an opening of the first hook faces the blade of the first jaw.

8. The tool of claim 7 wherein an opening of the second hook faces the blade of the first jaw.

9. The tool of claim 7 wherein an opening of the second hook is oriented transverse to the blade.

10. The tool of claim 9 wherein the opening of the second hook faces away from the handles.

11. The tool of claim 9 wherein the opening of the second hook faces toward the handles.

12. A hand-operated cutting tool, comprising:
a first handle operably coupled to a first jaw and a second handle operably coupled to a second jaw, the first jaw and the second jaw pivotally coupled to one another so that movement of the handles relative to one another between a closed position and an intermediate position and an open position, results in a corresponding movement of the jaws between a closed position and an intermediate position and an open position;
the first jaw comprising a blade, and the second jaw comprising a first hook configured to receive a first object, and a second hook configured to receive a second object;
wherein the second hook is configured to receive the second object when the handles are moved from the closed position to the intermediate position, so that the jaws are capable of receiving and severing the second object without moving the handles to the open position.

13. The tool of claim 12 wherein the second jaw comprises an internal side and an external side, and an end extending between the internal side and the external side.

14. The tool of claim 13 wherein the first hook is disposed along the internal side.

15. The tool of claim 14 wherein the second hook is disposed along the internal side and adjacent to the first hook.

16. The tool of claim 14 wherein the second hook is disposed along the end of the second jaw.

17. The tool of claim 14 wherein the second hook is disposed along the external side of the second jaw.

18. The tool of claim 17 wherein the second hook comprises an opening facing toward the end of the second jaw.

19. The tool of claim 17 wherein the second hook comprises an opening facing away from the end of the second jaw.

20. The tool of claim 12 further comprising a releasable stop configured to prevent opening of the handles beyond the intermediate position.

21. The tool of claim 20 further comprising a spring biasing the jaws toward the intermediate position.

22. A hand-operated cutting tool, comprising:
a first handle coupled to a first jaw, the first jaw comprising a blade;
a second handle coupled to a second jaw, the second jaw comprising a first hook configured to receive a first object, and a second hook configured to receive a second object, wherein the first hook is larger than the second hook, and the first object is larger than the second object;
a pivot connection coupling the first jaw to the second jaw so that movement of the handles from a closed position to an intermediate position exposes the second hook for receiving and cutting the second object only, and movement of the handles from the intermediate position to an open position exposes the first hook for receiving and cutting the first object.

23. The tool of claim 22 wherein the second jaw comprises a first side facing toward the blade and a second side facing away from the blade, and an end extending between the first side and the second side.

24. The tool of claim 23 wherein the first hook is disposed along the first side of the second jaw.

25. The tool of claim 24 wherein the second hook is disposed along the first side and adjacent to the first hook.

26. The tool of claim 24 wherein the second hook is disposed along the end of the second jaw.

27. The tool of claim 24 wherein the second hook is disposed along the second side of the second jaw.

28. The tool of claim 28 wherein the second hook comprises an opening facing toward the end of the second jaw.

29. The tool of claim 28 wherein the second hook comprises an opening facing away from the end of the second jaw.

30. The tool of claim 22 further comprising a spring biasing the handles from the closed position to the intermediate position and a stop selectively engageable to prevent opening movement of the handles beyond the intermediate position.
